(19) United States
(12) Patent Application Publication
(10) Pub. No.: US 2006/0055795 A1
(43) Pub. Date: Mar. 16, 2006

(54) Solid-state image pickup apparatus, control circuit, and control method of solid-state image pickup device

(76) Inventors: Tomomichi Nakai, Hashima-gun (JP); Shinya Fujii, Gifu-shi (JP); Hideki Takahashi, Gifu-shi (JP)

Correspondence Address: CANTOR COLBURN, LLP, 55 GRIFFIN ROAD SOUTH, BLOOMFIELD, CT, 06002, US

(21) Appl. No.: 11/225,484

(22) Filed: Sep. 13, 2005

(30) Foreign Application Priority Data
Sep. 16, 2004 (JP) JP2004-269315

(51) Int. Cl. H04N 5/235

(52) U.S. Cl. 348/229.1

(57) ABSTRACT

In a solid-state image pickup apparatus, a level adjustment control circuit sequentially executes a first level adjustment performing a level adjustment of a pickup image signal based on an electronic iris control signal for changing an exposure period in a solid-state image pickup device according to a luminance level of the pickup image signal, a second level adjustment performing the level adjustment of the pickup image signal based on a gain control signal for controlling a gain of a gain variable amplifier amplifying the luminance level of the pickup image signal, and a third level adjustment based on the electronic iris control signal to lengthen the exposure period to be longer than that of the first level adjustment in a second luminance level which is lower than a first luminance level of the pickup image signal and does not continue to the first luminance level.

### CROSS-REFERENCE TO RELATED APPLICATIONS

The entire disclosure of Japanese Application No. 2004-269315 including specification, claims, drawings and abstract is incorporated herein by reference in its entirety.

### BACKGROUND OF THE INVENTION

1. Field of the Invention

The present invention relates to a solid-state image pickup apparatus such as a video camera and a digital camera, a control circuit, and a control method of a solid-state image pickup device, all suitable for a level adjustment of an output signal of the solid-state image pickup apparatus.

2. Description of the Related Art

An example of a configuration of a related art image pickup apparatus 100 equipped with a CCD (Charged-Coupled Device) solid-state image pickup device 102 is shown in FIG. 1. The image pickup apparatus 100 includes a CCD solid-state image pickup device 102, a timing control circuit 104, a drive circuit 106, an analog signal processing circuit 108, an analog-to-digital conversion circuit (A/D conversion circuit) 110, a digital signal processing circuit 112, and a level adjustment control circuit 114.

When the CCD solid-state image pickup device 102 is a frame-transfer type, the CCD solid-state image pickup device 102 includes an image pickup portion 102i, a storage portion 102s, a horizontal transfer portion 102h, and an output portion 102d. The timing control circuit 104 receives a clock pulse of a predetermined frequency and an external control signal. Then, the timing control circuit 104 generates a control signal 105 controlling an image pickup, a vertical transfer, a horizontal transfer, and an output of the CCD solid-state image pickup device 102. The control signal 105 is inputted into the drive circuit 106. The drive circuit 106 receives the control signal 105 from the timing control circuit 104, and outputs clock pulses at necessary timing to each of the image pickup portion 102i, the storage portion 102s, the horizontal transfer portion 102h, and the output portion 102d of the CCD solid-state image pickup device 102.

The CCD solid-state image pickup device 102 receives clocks from the drive circuit 106, and performs image pickup, vertical transfer, horizontal transfer, and output. In the image pickup portion 102i, light receiving pixels are arranged in the form of a matrix. Light having entered the image pickup portion 102i is photo-electrically converted by the light receiving pixels, and information charges are generated. The information charges generated in the image pickup portion 102i are transferred to the storage portion 102s through a vertical shift register of the image pickup portion 102i by applying a vertical transfer clock φi. In the frame-transfer type CCD solid-state image pickup device 102 shown in FIG. 1, the information charges for one frame are held in the vertical shift register of the storage portion 102s. Successively, by applying a vertical transfer clock φs, the information charges are transferred from the storage portion 102s to the horizontal transfer portion 102h through the vertical shift register of the storage portion 102s by every one row. Furthermore, by applying a horizontal transfer clock φh, the information charges are transferred from the horizontal transfer portion 102h to the output portion 102d through a horizontal shift register of the horizontal transfer portion 102h by one pixel. The output portion 102d converts a charge quantity of every pixel into a voltage value, and a change of the voltage value is made to be an output of the CCD. Then, the change of the voltage value is further outputted to the subsequent stages by applying an output clock φd.

An output signal (an image signal of a subject) 107 of the CCD solid-state image pickup device 102 is inputted into the analog signal processing circuit 108. In the analog signal processing circuit 108, a correlated double sampling of the output signal 107 of the CCD solid-state image pickup device 102 is performed to remove reset noises in the output signal 107, and a luminance level of an analog signal is amplified to a predetermined level by a gain variable amplifier (Automatic Gain Control (AGC) amplifier). Then, after analog signal processing has been preformed, analog output signal is converted into a digital signal by analog-to-digital conversion (A/D conversion) in the A/D conversion circuit 110.

Then, the converted digital signal is inputted into the digital signal processing circuit 112, and various kinds of digital signal processing are performed to the inputted digital signal. Hereupon, the luminance level of the digital signal is amplified to a predetermined level by a digital amplifier (not shown) in the digital signal processing circuit 112. Then, various kinds of digital signal processing are performed to the digital signal besides the amplification by the digital amplifier, and the processed digital signal is outputted from the digital signal processing circuit 112.

Moreover, the level adjustment control circuit 114 receives the output signal 107 from the CCD solid-state image pickup device 102, and generates an analog gain control signal 116 controlling the AGC amplifier in the analog signal processing circuit 108 and a digital gain control signal 117 controlling the amplification factor (gain) of the digital amplifier in the digital signal processing circuit 112. Moreover, the level adjustment control circuit 114 generates an electronic iris control signal 115 to the timing control circuit 104 in order to change an exposure period in the image pickup portion 102i of the CCD solid-state image pickup device 102. As shown in FIG. 6, the level adjustment control circuit 114 integrates the output signal 107 from the CCD solid-state image pickup device 102 with an integrator 10, and then successively calculates an average luminance level in the image data for one screen of a subject in an operation/judgment unit 20. Then, the level adjustment control circuit 114 further generates the electronic iris control signal 115, the analog gain control signal 116, and the digital gain control signal 117 according to the calculated average luminance level. Based on the operation result thus obtained, the level adjustment of the output signal according to the average luminance level is performed.

Next, a general configuration of a conventional level adjustment control of an output signal is described. As shown in FIG. 7, as the average luminance level of a pickup image becomes lower, the level adjustment of an output signal by electronic iris control is first performed. As the average luminance level of the pickup image becomes further lower, the level adjustment control is constructed to sequentially shift to a level adjustment region by analog gain control and a level adjustment region by digital gain control.

Consequently, in the level adjustment control of the output signal in such the configuration, when the average luminance level of a pickup image is low, the level adjustment control first becomes the level adjustment region of the output signal by the electronic iris control. In an iris value calculation unit 30, the electronic iris control signal 115 which lengthens the exposure period of the CCD solid-state image pickup device 102 is generated from the average luminance level of the image data for one screen. Based on the electronic iris control signal 115, the timing control circuit 104 controls the clock pulse outputted to the CCD solid-state image pickup device 102. Hereby, the accumulation quantity of the information charges at the time of image pickup increases, and the average luminance level of the subsequent output signal becomes high. Incidentally, at the time of the electronic iris control, each of the analog gain and the digital gain are set to be the minimum.

The control is performed so that the exposure period may become longer as the average luminance level of a pickup image becomes lower. However, when the exposure period becomes the set maximum value, the level adjustment by the electronic iris control beyond the maximum value becomes impossible. Accordingly, when the average luminance level of a pickup image becomes still lower, amplification by analog gain control is performed following the level adjustment of the output signal by the electronic iris control. More specifically, when the iris value calculated in the iris value calculation unit 30 becomes the maximum (the exposure period becomes the maximum), the signal which has a flag indicating the state is outputted to an analog gain value calculation unit 40 from the iris value calculation unit 30, and the analog gain control is started based on the flag of the output signal.

In the analog gain control, the analog gain control signal 116 which increases the analog gain is generated from the average luminance level of the image data for one screen in the analog gain value calculation unit 40. The AGC amplifier in the analog signal processing circuit 108 receives the analog gain control signal 116, and adjusts the luminance level of the output signal by gain adjustment. Incidentally, at the time of the analog gain control, the exposure period by the electronic iris control is maintained to be the maximum, and the digital gain is the minimum.

Furthermore, when the luminance level of an output signal is also insufficient by the gain operation by the analog gain control, a gain operation by digital gain control is performed. More specifically, when the amplification by the AGC amplifier of the analog signal processing circuit 108 becomes the maximum, a signal including a flag indicating the state is outputted from the analog gain value calculation unit 40 to a digital gain value calculation unit 50, and the digital gain control is started based on the flag.

In the digital gain control, the digital gain control signal 117 which increases the digital gain is generated from the average luminance level of the image data for one screen in the digital gain value calculation unit 50. The digital amplifier in the digital signal processing circuit 112 receives the digital gain control signal 117, and adjusts the level of an output signal by a bit shift of a digital signal or the like. Incidentally, at the time of the digital gain control, the exposure period by the electronic iris control is maintained to be the maximum, and the analog gain also becomes the maximum.

As mentioned above, when the average luminance level of the pickup image becomes lower from the state of being high, the level of an output signal is adjusted in the order of the electronic iris control, the analog gain control, and the digital gain control.

On the other hand, when the average luminance level of the pickup image becomes higher from the state of being low, contrary to the above-mentioned operation, the luminance level of the output signal is adjusted in the order of the digital gain control, the analog gain control, and the electronic iris control.

Incidentally, even when the average luminance level of the pickup image becomes higher from the state of being low, the shift between each gain operation region is performed based on the flag of the signal outputted at the time of the shift between each gain operation region. More specifically, when the digital gain becomes the minimum at the time of the shift from the digital gain control to the analog gain control, the signal including the flag indicating the state is outputted from the digital gain value calculation unit 50 to the analog gain value calculation unit 40, and the analog gain control is started based on the flag of the output signal. Moreover, when the analog gain value becomes the minimum at the time of the shift from the analog gain control to the electronic iris control, the signal including the flag indicating the state is outputted from the analog gain value calculation unit 40 to the iris value calculation unit 30, and the electronic iris control is started based on the flag of the output signal.

Next, according to the level adjustment control of the pickup image mentioned above, when the average luminance level of the pickup image lowers to the grade at which the analog gain control or the digital gain control is performed, the exposure period has become long to the maximum by the electronic iris control. Consequently, there is a problem in which deterioration of image quality such as blurring of an image is frequently generated by a movement of the CCD solid-state image pickup device 102 during an exposure period owing to camera movement.

### SUMMARY OF THE INVENTION

According to the present invention, a solid-state image pickup apparatus includes a solid-state image pickup device receiving external light to output a pickup image signal of a subject image, a signal processing circuit including a gain variable amplifier amplifying a luminance level of the pickup image signal, a level adjustment control circuit generating an electronic iris control signal for changing an exposure period in the solid-state image pickup device according to the luminance level of the pickup image signal and a gain control signal for controlling a gain of the gain variable amplifier, and a timing control circuit controlling the exposure period of the solid-state image pickup device based on the electronic iris control signal, wherein the level adjustment control circuit sequentially executes a first level adjustment performing a level adjustment of the pickup image signal based on the electronic iris control signal in a first luminance level region of the pickup image signal, a second level adjustment performing a level adjustment of the pickup image signal based on the gain control signal for controlling the gain of the gain variable amplifier, and a third level adjustment performing a level adjustment of the pickup image signal based on the electronic iris control signal lengthening the exposure period to be longer than that of the first level adjustment region in a second luminance which is lower than a first luminance level of the pickup image signal and does not continue to the first luminance level.

### BRIEF DESCRIPTION OF THE DRAWINGS

The above and other objects, advantages, and features of the present invention will be more apparent from the following description taken in conjunction with the accompanying drawings in which:

FIG. 1 is a diagram showing an example of a configuration of a related artimage pickup apparatus equipped with a CCD solid-state image pickup device;

FIG. 2 is a block diagram showing a circuit configuration of a level adjustment control circuit according to an embodiment of the present invention;

FIG. 3 is a diagram showing an example of a shift pattern of a level adjustment region in level adjustment control of an output signal of the present embodiment;

FIG. 4 is a diagram showing another shift pattern of the level adjustment region in the level adjustment control of the output signal of the present embodiment;

FIG. 5 is a diagram showing a further shift pattern of the level adjustment region in the level adjustment control of the output signal of the present embodiment;

FIG. 6 is a block diagram showing a circuit configuration of a related art level adjustment control circuit; and

FIG. 7 is a diagram showing a shift pattern of a level adjustment region in level adjustment control of a related art output signal.

### DETAILED DESCRIPTION OF THE PREFERRED EMBODIMENTS

Best modes of carrying out the present invention will be described in further detail using various embodiments with reference to the accompanying drawings.

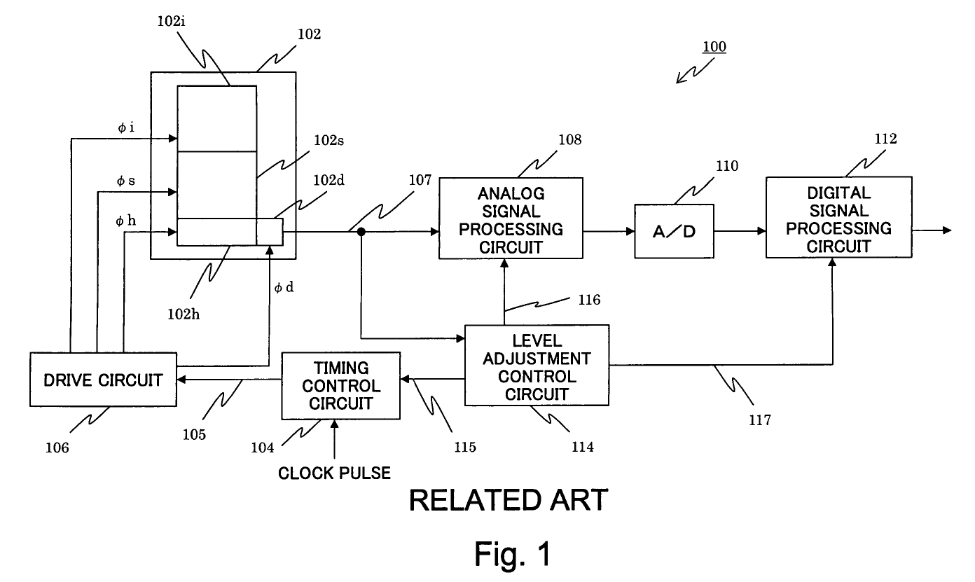

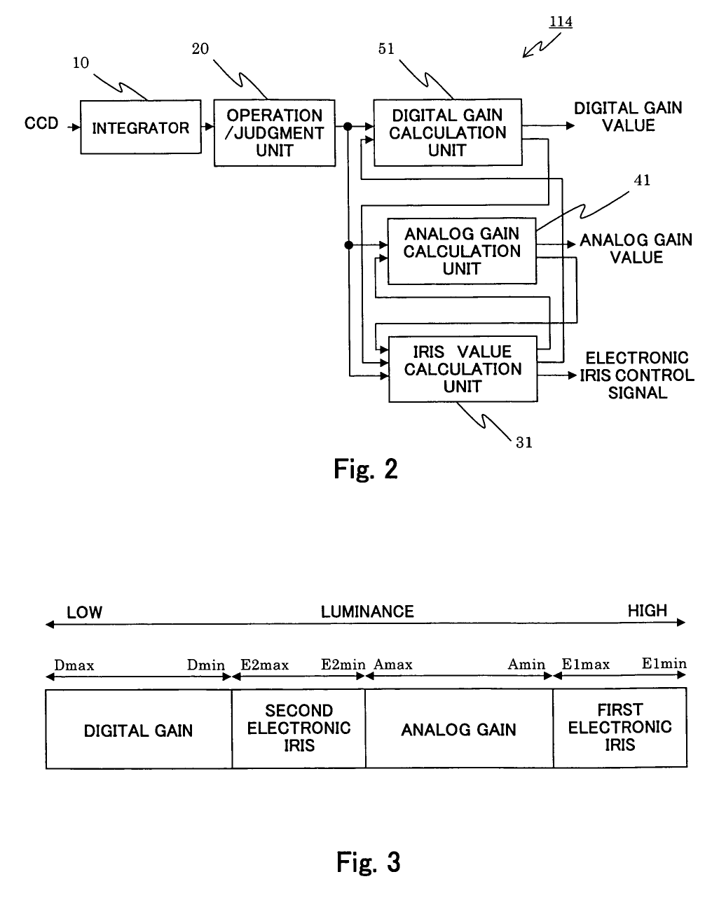

In the following, an embodiment of the present invention is described with reference to the attached drawings. FIG. 2 is a diagram showing the circuit configuration of a level adjustment control circuit 114 according to the present embodiment, and FIG. 3 is a diagram showing an example of a shift pattern of a level adjustment region performed by the level adjustment control circuit 114 of FIG. 2. Parts that are the same as shown in FIG. 1 are referenced with the same numbers.

In the present embodiment, an image pickup apparatus equipped with a CCD solid-state image pickup device includes a CCD solid-state image pickup device 102, a timing control circuit 104, a drive circuit 106, an analog signal processing circuit 108, an analog-to-digital conversion circuit (A/D conversion circuit) 110, a digital signal processing circuit 112, and the level adjustment control circuit 114, similarly to the configuration shown in FIG. 1, and each unit performs the same operation as the conventional one.

Then, also in the level adjustment control circuit 114 of the present embodiment, similarly to the conventional one, the level adjustment control circuit 114 receives the output signal from the CCD solid-state image pickup device 102, and generates analog gain control signals 116 controlling an AGC amplifier in the analog signal processing circuit 108, and digital gain control signals 117 controlling the amplification factor (gain) of a digital amplifier in the digital signal processing circuit 112. Moreover, the level adjustment control circuit 114 generates an electronic iris control signal 115 to the timing control circuit 104 in order to change an exposure period in an image pickup portion 102i of the CCD solid-state image pickup device 102. As shown in FIG. 2, the level adjustment control circuit 114 of the present embodiment integrates an output signal 107 from the CCD solid-state image pickup device 102 with an integrator 10, and then successively calculates an average luminance level in image data for one screen of a subject in an operation/judgment unit 20. Then, the level adjustment control circuit 114 further generates the electronic iris control signal 115, the analog gain control signal 116, and the digital gain control signal 117 according to the calculated average luminance level. Based on the operation result obtained, the level adjustment of the output signal according to the average luminance level is automatically performed.

In the level adjustment control of an output signal according to the present embodiment, as shown in FIG. 3, a region of an electronic iris is configured to include a first electronic iris region having a limit value E1max of a short exposure period, and a second electronic iris region having a limit value E2max of a long exposure period. In the level adjustment control of the output signal, the level adjustment regions are formed to include the two kinds of electronic iris control. When an average luminance level of a pickup image is low, first the level adjustment region by the first electronic iris region is applied. Then, as the average luminance level of a pickup image becomes lower, the level adjustment control sequentially shifts to a level adjustment region by analog gain control, a level adjustment region by the second electronic iris region, and the level adjustment region by the digital gain control.

Consequently, in the level adjustment control of the output signal in such a configuration, the level adjustment control first becomes the level adjustment region by the first electronic iris region. In an iris value calculation unit 31, an iris value of the electronic iris is calculated, and the electronic iris control signal 115 which lengthens the exposure period of the CCD solid state image pickup device 102 is generated based on the iris value for heightening the level of the output signal. Then, the timing control circuit 104 receives the electronic iris control signal 115, and controls a clock pulse to lengthen exposure period of the CCD solid-state image pickup device 102. Hereby, an accumulation quantity of information charges at the time of image pickup increases, and an average luminance level of the subsequent output signals becomes higher.

Here, when the calculated iris value becomes the limit value E1max of the shorter exposure period mentioned above, the level adjustment control shifts to the level adjustment region by the analog gain control. More specifically, when the iris value becomes the limit value E1max of the short exposure period, a signal having a flag indicating a state is outputted from an iris value calculation unit 31 to an analog gain value calculation unit 41, and the analog gain control is started based on the flag of the output signal.

In the analog gain control, an analog gain value is calculated in the analog gain value calculation unit 41. The AGC amplifier in the analog signal processing circuit 108 receives the analog gain value, and adjusts the luminance level of the output signal by gain adjustment.

Furthermore, when the luminance level of an output signal is also insufficient by the level adjustment of the output signal by the analog gain control, the level adjustment control shifts to the level adjustment region by the second electronic iris region. More specifically, when the analog gain value becomes a maximum Amax (the maximum of the amplification by the AGC amplifier), a signal having a flag indicating the state is outputted from the analog gain value calculation unit 41 to the iris value calculation unit 31, and the control by the second electronic iris region is started based on the flag of the output signal.

Also in the control by the second electronic iris region, similarly to the control by the first iris region, the electronic iris control signal 115 which lengthens the exposure period of the CCD solid-state image pickup device 102 is generated based on the iris value in order to heighten the level of the output signal. Then, the timing control circuit 104 receives the electronic iris control signal 115, and controls the clock pulse to lengthen the exposure period of the CCD solid-state image pickup device 102. Hereby, the accumulation quantity of the information charges at the time of image pickup increases, and the average luminance level of the subsequent output signals becomes higher.

Then, when the iris value calculated by the control by the second electronic iris region becomes the limit value E2max of the long exposure period mentioned above, further level adjustment by the electronic iris control becomes impossible. Accordingly, when the average luminance level of the pickup image becomes further lower, the level adjustment control shifts to the level adjustment region by the digital gain control successively to the level adjustment of the output signal by the second electronic iris region. More specifically, when the iris value becomes the limit value E2max (the maximum of the exposure period), a signal having a flag indicating the state is outputted from the iris value calculation unit 31 to a digital gain value calculation unit 51, and the digital gain control is started based on the flag of the output signal.

In the digital gain control, a digital gain value is calculated in the digital gain value calculation unit 51. Then, the digital amplifier in the digital signal processing circuit 112 receives the digital gain value, and adjusts the luminance level of the output signal by a bit shift of a digital signal or the like.

As mentioned above, when the average luminance level of a pickup image becomes lower from the state of being high, the level of an output signal is adjusted in the order of the electronic iris control (the first level adjustment), the analog gain control, the electronic iris control (the second level adjustment), and the digital gain control.

Incidentally, when the average luminance level of a pickup image becomes higher from the state of being low, contrary to the above-mentioned operation, the luminance level of an output signal is adjusted in the order of the digital gain control, the electronic iris control (the second electronic iris region), the analog gain control, and the electronic iris control (the first electronic iris region). The switching of each control is performed by the inputting and the outputting of a flag between each calculation units 31, 41, and 51 similarly in the case where the average luminance level changes from a higher state to a lower state.

Furthermore, because the exposure period is limited to a period shorter than the maximum value in the first level adjustment operation by the electronic iris control, the influences owing to camera movement due to the lengthening of the exposure period can be reduced. Consequently, deterioration of image quality owing to the movement of the solid-state image pickup device during an exposure period caused by camera movement can be suppressed.

Although the embodiment described above is configured such that, when the average luminance level of a pickup image lowers from a state of being high, the level of an output signal is adjusted in the order of the electronic iris control (the first electronic iris region), the analog gain control, the electronic iris control (the second electronic iris region), and the digital gain control, the aspect of the configuration is not limited to the above mentioned one.

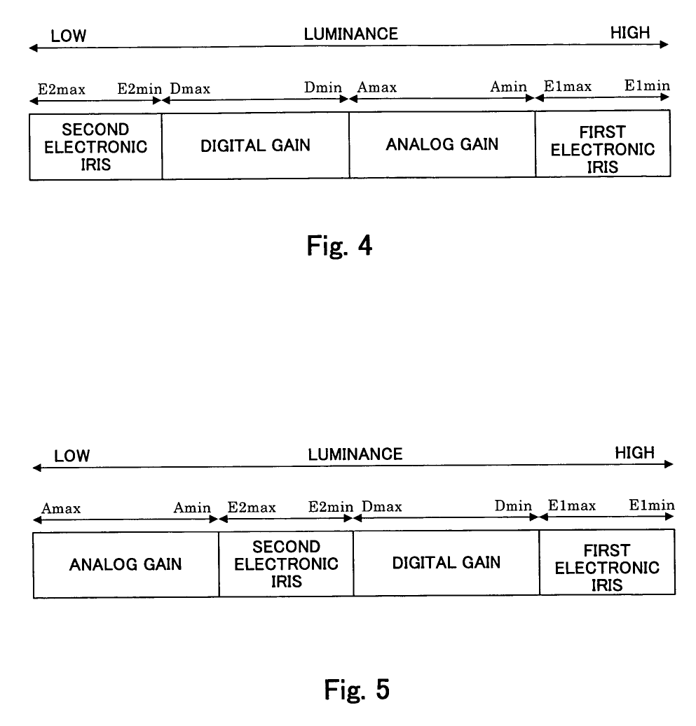

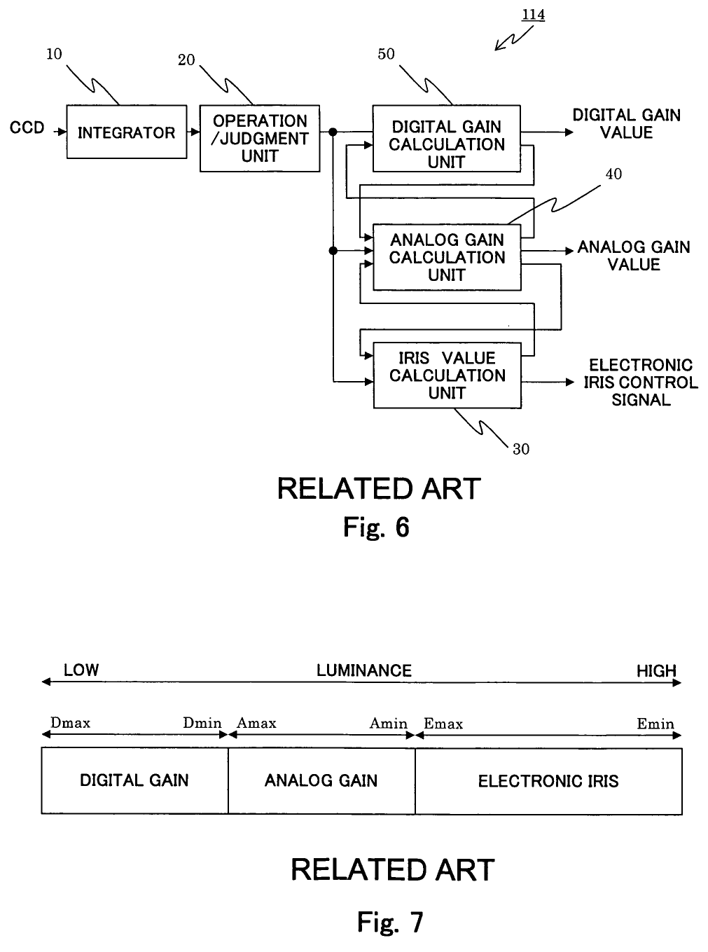

For example, as shown in FIG. 4, the level adjustment may be constructed so that the level of an output signal may be adjusted in the order of the electronic iris control (the first electronic iris region), the analog gain control, the digital gain control, and the electronic iris control (the second electronic iris region). Moreover, as shown in FIG. 5, the level adjustment may be constructed so that the level of an output signal may be adjusted in the order of the electronic iris control (the first electronic iris region), the digital gain control, the electronic iris control (the second electronic iris region), and the analog gain control. However, if the digital gain control is performed before the analog gain control, the dynamic range of a pickup image signal deteriorates. Accordingly, it is desirable to perform the analog gain control before the digital gain control. Also in these configurations, the control method of the level adjustment of an output signal can be sequentially shifted similarly to the above-mentioned embodiment by the inputting and the outputting of a signal having a flag between each of the calculation units 31, 41, and 51.

Moreover, although the level adjustment regions by the electronic iris control are set to be two kinds, the level adjustment regions may be three kinds. For example, the level adjustment control may be constructed so that the level of an output signal may be adjusted in the order of the electronic iris control (the first electronic iris region), the analog gain control, the electronic iris control (the second electronic iris region), the digital gain control, and the electronic iris control (a third electronic iris region).

Moreover, the embodiment mentioned above adopts the configuration of performing the calculation of the average luminance level of the image data of a subject for one screen and the judgment processing of the optimum level adjustment control of an output signal according to an average luminance level by an operation/judgment unit 20. However, the operation/judgment unit 20 may be divided into an operation unit and a judgment unit so that the operation unit may calculate the average luminance level of the image data for one screen of a subject, and that the judgment unit may judge the optimum level adjustment control method of an output signal according to the average luminance level.

Moreover, although the embodiment mentioned above adopts the configuration which maintains the analog gain value and the digital gain value to definite values in the first electronic iris region and the second electronic iris region, respectively, and which maintains the iris value of the electronic iris to a definite value in the level adjustment regions by the analog control and the digital control in the above-mentioned embodiment, the configuration is not limited to the one mentioned above. For example, it is possible to adopt a configuration in which the analog gain value is changed at a rate smaller than that in the level adjustment region by the analog control in the first electronic iris region, or to adopt a configuration in which the iris value is changed at a change rate smaller than that of the first or the second electronic iris region in the level adjustment region by the analog control.

As mentioned above, according to the present invention, the adjustment of the exposure period by the electronic iris control is divided into two steps to be performed. Herewith, the generation of the deterioration of image quality owing to the movement of the solid-state image pickup device 102 during an exposure period can be suppressed.

Although the invention has been described with respect to a specific embodiment for a complete and clear disclosure, the appended claims are not to be thus limited, but are to be construed as embodying all modifications and alternative constructions that may occur to one skilled in the art which fairly fall within the basic teaching set forth.

What is claimed is:

1. A solid-state image pickup apparatus, comprising:
a solid-state image pickup device receiving external light to output a pickup image signal of a subject image;
a signal processing circuit including a gain variable amplifier amplifying a luminance level of the pickup image signal;
a level adjustment control circuit generating an electronic iris control signal for changing an exposure period in the solid-state image pickup device according to the luminance level of the pickup image signal, and a gain control signal for controlling a gain of the gain variable amplifier; and
a timing control circuit controlling the exposure period of the solid-state image pickup device based on the electronic iris control signal, wherein:
the level adjustment control circuit sequentially executes a first level adjustment performing a level adjustment of the pickup image signal based on the electronic iris control signal in a first luminance level region of the pickup image signal;
a second level adjustment performing the level adjustment of the pickup image signal based on the gain control signal for controlling the gain of the gain variable amplifier; and
a third level adjustment performing the level adjustment of the pickup image signal based on the electronic iris control signal lengthening the exposure period to be longer than that of the first level adjustment in a second luminance which is lower than a first luminance level of the pickup image signal and does not continue to the first luminance level.

2. The solid-state pickup apparatus according to claim 1, wherein the signal processing circuit is either one of an analog signal processing circuit and a digital signal processing circuit.

3. A control circuit of a solid-state image pickup device, comprising:
a signal processing circuit including a gain variable amplifier amplifying a luminance level of a pickup image signal outputted from the solid-state image pickup device;
a level adjustment control circuit generating an electronic iris control signal for changing an exposure period in the solid-state image pickup device according to the luminance level of the pickup image signal, and a gain control signal for controlling a gain of the gain variable amplifier; and
a timing control circuit controlling the exposure period of the solid-state image pickup device based on the electronic iris control signal, wherein:
the level adjustment control circuit sequentially executes a first level adjustment performing a level adjustment of the pickup image signal based on the electronic iris control signal in a first luminance level region of the pickup image signal;
a second level adjustment performing the level adjustment of the pickup image signal based on the gain control signal for controlling the gain of the gain variable amplifier; and
a third level adjustment performing the level adjustment of the pickup image signal based on the electronic iris control signal lengthening the exposure period to be longer than that of the first level adjustment in a second luminance which is lower than a first luminance level of the pickup image signal and does not continue to the first luminance level.

4. The control circuit of the solid-state image pickup device according to claim 3, wherein
the level adjustment control circuit includes an iris value calculation unit generating the electronic iris control signal, and a gain value calculation unit generating the gain control signal, wherein:
the iris value calculation unit outputs a signal instructing an operation start to the gain value calculation unit accompanying a shift of the level adjustment; and
the gain value calculation unit outputs a signal instructing an operation start to the iris value calculation unit accompanying the shift of the level adjustment.

5. The control circuit of the solid-state image pickup device according to claim 3, wherein each of the signal processing circuit and the gain value calculation unit is an analog signal processing circuit and an analog gain value calculation unit, or a digital signal processing circuit and a digital gain value calculation unit.

6. The control circuit of the solid-state image pickup device according to claim 4, wherein the signal processing circuit and the gain value calculation unit are either one of an analog signal processing circuit and an analog gain value calculation unit, and a digital signal processing circuit and a digital gain value calculation unit.

7. A control method of a solid-state image pickup device, comprising:
a signal processing step of including a step of amplifying a luminance level of a pickup image signal outputted from the solid-state image pickup device with a gain variable amplifier;
a level adjustment control step of generating an electronic iris control signal for changing an exposure period in the solid-state image pickup device according to the luminance level of the pickup image signal, and a gain control signal for controlling a gain of the gain variable amplifier; and
a timing control step of controlling the exposure period of the solid-state image pickup device based on the electronic iris control signal, wherein:
the level adjustment control step sequentially executes a first level adjustment step of performing a level adjustment of the pickup image signal based on the electronic iris control signal in a first luminance level region of the pickup image signal;
a second level adjustment step of performing the level adjustment of the pickup image signal based on the gain control signal for controlling the gain of the gain variable amplifier; and
a third level adjustment step of performing the level adjustment of the pickup image signal based on the electronic iris control signal lengthening the exposure period to be longer than that of the first level adjustment step in a second luminance level which is lower than a first luminance level of the pickup image signal and does not continue to the first luminance level.
